(19) United States
(12) Patent Application Publication
(10) Pub. No.: US 2007/0250636 A1
(43) Pub. Date: Oct. 25, 2007

(54) Global interactive packet network broadcast station

(76) Inventor: Sean Stephens, Santa Clarita, CA (US)

Correspondence Address: COURTNEY STANIFORD & GREGORY LLP, P.O. BOX 9686, SAN JOSE, CA, 95157, US

(21) Appl. No.: 11/786,011

(22) Filed: Apr. 10, 2007

Related U.S. Application Data
(60) Provisional application No. 60/745,598, filed on Apr. 25, 2006.
(60) Provisional application No. 60/842,073, filed on Sep. 1, 2006.

(51) Int. Cl. G06F 15/16

(52) U.S. Cl. 709/231; 709/233

(57) ABSTRACT

Streaming systems and methods are described for integrating and distributing live, pre-recorded and/or on-demand media content via a packet network. The streaming systems receive a plurality of content signals from live, pre-recorded and/or on-demand content sources. The streaming systems establish a streaming session for a selected content signal that is transmitted to a remote client computer over a packet switched data network. The selected content signal is streamed over the data network during the streaming session. The streaming of the selected content signal is managed using a server. The server communicates with components including a viewer access database, a content database that includes names and titles to available content from available sources, a viewer advertising database, and/or an accounting database that includes fees to be applied to title owners of content signals when selected for transmission over the packet switched data network.

### RELATED APPLICATIONS

This application claims the benefit of U.S. Patent Application No. 60/745,598, filed Apr. 25, 2006. This application claims the benefit of U.S. Patent Application No. 60/842,073, filed Sep. 1, 2006.

### TECHNICAL FIELD

The invention relates to a system for distributing video and other types of data from a centralized data server center to client devices or display terminals across a packet network transport system. More particularly, the invention relates to a network broadcast station for transmitting data or streaming video images across a packet based network such as the Internet.

### BACKGROUND

Consumers are now demanding an ever expanding variety of content including audio, video, text, navigation, and others types of data from the broadcast industry. But there are three primary problems or limitations arising from conventional broadcast technology. A first problem relates to limited channel availability. There are restrictions imposed by the current channel based system having a limited number of “channels” for displaying content, and therefore limiting the quantity of content available to consumers. A second problem with conventional broadcast technology is that the delivery technology available is limited. The limitations arising from reliance on radio technology and associated cabling costs in order to reach subscribers scattered over a wide geographic area are inherent drawbacks imposed by the basic architecture of the broadcast system. A third problem with conventional broadcast systems is that there are limited content management systems available to control distribution of content. These limitations may relate to organizing a wide variety of video formats available, the various video standards type and category of digital content which by and large are still managed by analog record/playback systems or hybrid systems. These management systems often involve the use of computers and analog recorders to organize content and to provide a suitable and user friendly interface for its delivery to valid subscribers. At the same time, access to content should be denied to unauthorized users. The lack of effective content management in conventional broadcast systems is evidenced by numerous missed deadlines imposed by the government over the past several years for the migration or transition from convention television broadcasting to high definition (HD) television.

As a result of the aforementioned issues, broadcast stations have developed a variety of divergent technologies and transport systems designed and intended to organize and transport content to subscribers. These technologies range from digital and analog radio waves to a variety of Internet technologies distributed from independent servers and requiring a variety if different software applications to implement as well as user interfaces displayed on a variety of hardware devices. Current solutions however fail to provide a simpler and more streamlined content distribution and management system.

Accordingly, there is a need for an efficient broadcast network capable of delivering a wide variety of content such as video and other data across a wide area with reliable network management and distribution capabilities.

### INCORPORATION BY REFERENCE

All publications, patents and/or patent applications mentioned in this specification are herein incorporated by reference to the same extent as if each individual publication, patent and/or patent application was specifically and individually indicated to be incorporated by reference.

### BRIEF DESCRIPTION OF THE FIGURES

FIG. 1 is a block diagram of a network broadcast streaming system, under an embodiment.

FIG. 2 is a flow diagram of streaming data across a packet network, under an embodiment.

### DETAILED DESCRIPTION

Systems and methods are described herein for delivering content over a packet based network from a broadcast station to remote client devices. The systems and methods described herein are collectively referred to as “streaming systems” but are not so limited. A single integrated streaming system can be provided with access to various databases of content through a user interface or menu system. A common interface or transport system can be implemented in accordance with the principles of the streaming systems to establish a one stop global broadcast network.

An aspect of the streaming systems described herein provides an integrated, database-driven client-server system designed to operate over an interactive packet network such as the Internet. Selected content can be delivered to one or more subscribers via any technology configured to support Internet connectivity. The benefits of the streaming systems may be carried out over traditional medium such as digital subscriber line (DSL), cable, satellite connectivity and/or other alternatives being developed which require no terrestrial wiring to provide Internet access from virtually everywhere globally. The delivery of selected content in accordance with the streaming systems via a packet network affords a cost effective solution for providing higher quality video images and fewer problems related to signal loss compared to conventional analog broadcast networks.

Another aspect of the streaming systems described herein is that it allows for lowered setup and operating costs because it can be implemented with existing computer and network technology. The concepts of the streaming systems can continue to be applied and expanded as telecommunication technology continues to improve.

An embodiment of the streaming systems described herein provides a broadcast system that is based on a centralized server system coupled or connected to a variety of diverse or heterogeneous content sources. The content sources may be organized in a central database along with lists of subscriber accounts and advertisers, or alternatively, the centralized server system may actually comprise one or more interconnected computers and databases. Unlike conventional broadcast systems, the streaming systems do not rely on the video viewer or client devices to select from multiple streams of content broadcast simultaneously by the central broadcast system. Because only user or subscriber based content is delivered at a given time, such client devices that receive streaming content do not require that the viewer or client device have a built-in or dedicated mechanism to differentiate a variety of different forms of content and to select an appropriate display technology to display the content. Rather more cost effective devices can be used to perform their primary purpose of just serving as a video viewer for the broadcast stream.

An embodiment of the streaming systems includes a server based system content selection and network management system. The delivery and management of video and other data across a packet based network can be done from powerful central servers rather than relying on the capabilities on the receiver or client device side. Accordingly, any device capable of supporting Internet connectivity (e.g., through a basic browser) can view content without requiring substantial memory or computing power to differentiate or support various forms of content that may require additional software or downloaded players such as RealPlayer media player of RealNetworks or QuickTime from Apple Computer, Inc. This allows for the use of less sophisticated and less expensive client devices that can be equipped to merely display content and do not require the complicated selection mechanisms used in conventional broadcast systems described above.

In another embodiment of the streaming systems, a centralized broadcast server and content database management system may provide access to a subscriber utilizing an existing computer and software, a client device, a mobile phone, a dedicated video terminal or other inexpensive dedicated device. Such devices may include embedded application(s) or software that allows a user to select and view from menus created within the central server system from a wide variety of content. The viewing of menus can be managed as a separate transmission to users, or alternatively, it can be combined with the delivery of some selected content from the centralized server system. Selected content may be streamed directly to a client device upon selection where it is displayed for the subscriber to view. 10015] Another aspect of the streaming systems provides an interactive broadcast station over a packet based network. Because this system is interactive with a user and menu/database driven, there are no “channels” or tuners but rather “choices” (v-channels or virtual channels) or selections displayed from which the viewer can select media for display. In addition, a viewer may browse for content from an available selection and perform “searches” for programming. These searches can be based on various types of parameters or criteria including searching for a participant name (e.g., actor, actress, producer, director, character, team, team player, etc.), movie title, plot point, sports figure, game date, race car number, and sports score, to name a few. The menu driven selection of different types of content also affords content producers more opportunity to have their content viewed since there is no longer a channel limit as with conventional broadcast systems.

An embodiment of the streaming systems allows consumers to instantly select from and view content from a virtually unlimited and expandable library, including on-demand or live content sources connected to or from within a global broadcast system.

Other aspects of the streaming systems will be further appreciated and understood when considered in conjunction with the following description and accompanying drawings. While the following description may contain specific details describing particular embodiments of the streaming systems, this should not be construed as limitations to the scope of the streaming systems but rather as an exemplification of particular embodiments. For each aspect of the streaming systems, many variations are possible as suggested herein that are known to those of ordinary skill in the art. A variety of changes and modifications can be made within the scope of the streaming systems without departing from the spirit of the streaming systems.

For purposes of describing the streaming systems in the following detailed description, it shall be understood that certain terms may be construed as understood by those of ordinary skill in the field. There may be selected terms that may be further defined as follows in describing the streaming systems herein.

The term “packet network” contains two layers a physical layer and a protocol layer.

The term “streaming” refers to a process for transmitting audio, video, audio/video and other types of continuous signals, which have been digitized, over packetized data networks such as the Internet for nearly contemporaneous playback. A signal is streamed by encoding the signal as a series of data packets and sending the data packets over a packet switched data network in a manner that supports contemporaneous or nearly contemporaneous playback on a client device using a player application or embedded software in the device. Presently, there are several streaming standards and approaches, including those used by the RealPlayer.R™ of RealNetworks, Inc, the Windows Media Player.™ of Microsoft Corporation, and the QuickTime.R™ player of Apple Computer, Inc., for encoding and controlling the stream. Prerecorded content, such as sound recordings and video tapes, and “live” content, such as retransmission of radio and television broadcasts, are presently being transmitted over the Internet using streaming. Graphical advertisements are also transmitted for displaying on a client device screen in connection with the playing of the media stream. In addition, audio, video or other streaming media advertisements are sometimes transmitted prior to transmission of the content.

When used herein, the term “computer” refers to any device capable of communicating over a data network and decoding for nearly simultaneous playback of an incoming data stream that is encoded with audio and/or video signals. Such a stream is referred to herein as a media stream. The audio and/or video signals, once decoded, may be played back on the computer or another device for reproducing the sound and/or video represented by the signals. A computer may further include or be associated with a visual display. In the embodiments described herein, a computer takes the form of a microprocessor-based personal computer, that includes a general purpose microprocessor, temporary program and data storage, such as random access memory, permanent program and data storage, such as a disk drive, a monitor or other visual display for displaying graphics, a sound card for decoding and converting digital signals to analog signals, and a keyboard and/or mouse for receiving data from a user. However, computers may also include limited function Internet appliances having limited display, data, data input, and user programming capabilities, such as personal organizers, telephones and other limited or special purpose devices.

The term “packet network” refers generally to one or more interconnected public and/or private networks that route packets or frames of data, as opposed to circuit switched networks and television or radio broadcast networks. A packet network includes the system of interconnected computer networks known as the Internet that route data packets using the Internet Protocol (IP) as it exists presently now or in future versions or releases.

The “physical layer” describes the functions of the cables, connectors, receivers, transmitters, voltages, wavelengths for encoding the bits, etc. used to connect the nodes in the network. Some but not all examples of this would be coaxial cable, unshielded copper pair (DSL, dial-up, etc.), fiber optics, wireless (WiFi, UHF, satellite, VHF, etc).

The “protocol layer” may be defined as all transmission processing above the physical layer, and is comprised of any or all of the following layers: data link layer, network layer, transport layer, session layer, presentation layer, and application layers.

The “data link layer” transfers data between adjacent network nodes in a wide area network or between nodes on the same local area network segment. The data link layer provides the functional and procedural means to transfer data between network entities and might provide the means to detect and possibly correct errors that may occur in the physical layer.

The “network layer” addresses messages and translates logical addresses and names into physical addresses. It also determines the route from the source to the destination devices and manages traffic problems, such as switching, routing, and controlling the congestion of data packets. One but not the only example of this would be Internet Protocol (IP).

The “transport layer” provides transparent transfer of data between hosts. It is usually responsible for end-to-end error recovery and flow control, and ensuring complete data transfer. A purpose of the transport layer is to provide transparent transfer of data between devices, thus relieving the upper layers from any concern with providing reliable and cost-effective data transfer. Some but not all examples of this would be AppleTalk Echo Protocol (AEP), AppleTalk Transaction Protocol (ATP), CUDP, IL, NBP, NetBEUI, RTMP, SPX, TCP, UDP, SCTP, RTP and TCP (transmission control protocol).

The “session layer” provides the mechanism for managing the dialogue between device application processes. It provides for either duplex or half-duplex operation and establishes checkpointing, adjournment, termination, and restart procedures. Some but not all examples of this would be NetWare Core Protocol (NCP), Server Message Block (SMB), Network File System (NFS), AppleTalk Session Protocol (ASP), AppleTalk Data Stream Protocol (ADSP), Named Pipes, NBT, NetBIOS, NWLink, Printer Access Protocol (PAP), Zone Information Protocol (ZIP).

The “presentation layer” is responsible for the delivery and formatting of information to the application layer for further processing or display. It relieves the application layer of concern regarding syntactical differences in data representation within the device. Some but not all examples of this would be HTTP/HTML, ASN.1, XML, TDI, XDR, NDR, SNMP, FTP, Telnet, SMTP, NetWare Core Protocol, Apple Filing Protocol (AFP).

The “application layer” interfaces directly to and performs common application services for the application processes. It also issues requests to the presentation layer. Some but not all examples of this would be Appletalk Filing Protocol (AFP), AOL Instant Messenger Protocol (AIM), Advanced Program-to-Program Communication (APPC), BitTorrent Coherent File Distribution Protocol (CFDP), Dynamic Host Configuration Protocol (DHCP), File Transfer Access and Management (FTAM), File Transfer Protocol (FTP), Gopher protocol, HyperText Transfer Protocol (HTTP), Internet Message Access Protocol (IMAP), Internet Relay Chat (IRC), iTunes Music Store Protocol (iTMS), Lightweight Directory Access Protocol (LDAP), Modbus, NIS, Network Information Service (NIS), Network News Transfer Protocol (NNTP), Post Office Protocol (POP3), Session Initiation Protocol (SIP), Simple Mail Transfer Protocol (SMTP), Simple Network Management Protocol (SNMP), Secure Shell (SSH), TELEphone NETwork (TELNET), Trivial File Transfer Protocol (TFTP), Time Stamp Protocol (TSP), X.400, X.500, Extensible Messaging and Presence Protocol (XMPP)

The term “integrating” or “integrated” relates to organizing and allowing selection from either live, on-demand or pre-recorded sources within the same system.

The term “live” can be defined as content that is transmitted and available for viewing simultaneously or substantially simultaneously at the time of the event.

The term “pre-recorded” can be defined as content that is transmitted at a time determined by the content provider.

The term “on-demand” can be defined as stored content that is transmitted and viewed at a time selected by the viewer.

The term “content” can be defined as any form of visual or audio information such as but not limited to entertainment, telemetry, monitoring, navigation or surveillance and may be provided by a computer or an embedded application operating on a dedicated device which relays digital content collected by a digital or analog input device such as a video camera, microphone, transponder, global positioning system (GPS), unit, etc. and formatted by means of an appropriate digital converter to the central server system.

The term “stored content” can be defined as content that has been digitally formatted for later transmission and may be provided by a computer or an embedded application operating on a dedicated device which relays digital content collected by a digital or analog input device such as a video camera, microphone, transponder, GPS, unit, etc. and formatted by means of an appropriate digital converter to the central server system.

A “server” can be defined as a single server or multiple interconnected servers located at a central geographic area or in multiple geographic areas, including a load balancer that can be included within a multiple server configuration.

A “client device” can be defined as an apparatus including a software program operating on a computing device, phone, handheld device or embedded software program operating on a dedicated device designed to connect to a server for the purpose of receiving and displaying audio or video content transmitted by the server. The “client device” can also referred to as a “client computer” or “terminal” but is not so limited.

A “guest session” may be defined as a data transmission period with a server wherein all transmission is conducted via a packet network initiated by a client device without authentication.

An “authenticated session” may be defined as a data transmission period with a server wherein all transmission is conducted via a packet network initiated by a client device and authenticated against valid username and valid password contained in some data storage format.

The term “tracking information” can be defined as information necessary to uniquely identify a client device initiating either a guest session or an authenticated session. The identifying information contains but is not limited to authenticated account identifier, IP address, time, date, content requested, links requested, advertisements requested and advertisements viewed.

The phrase “data storage format” relates to the manner in which a system stores content for recording and retrieving information for future access on computer readable medium devices, including but not limited to Random Access Memory (RAM), a hard drive, an optical drive, a flash drive, etc.

The term “v-Channel” or “virtual channel” may be defined as a selected collection of content sharing some common element including but not limited to subject matter, content type, content source, date, time, content location, content provider, etc. represented by a direct link or a representation of a link

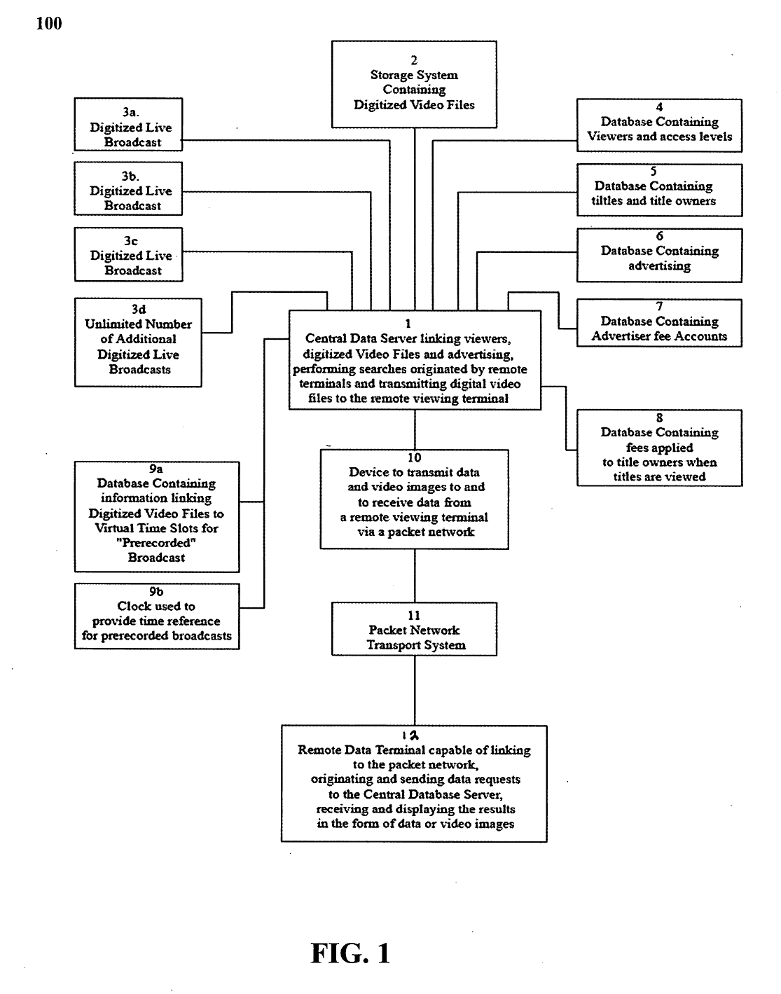

FIG. 1 is a block diagram of a network broadcast streaming system 100, under an embodiment. The network broadcast streaming system 100, or streaming system 100, includes a central data server 1, also referred to as a server 1, coupled to numerous content sources 2/3a-3d. The streaming system 100 provides streaming or transmission of media using video, audio, and/or audio/video signals as a data stream for example. One or more client devices 12 (e.g. remote computer) can function as devices by which users view and enjoy the streaming broadcast.

The client devices 12 can be coupled or connected directly or indirectly, to a packet network 11, such as through a dial up connection, a wireless gateway, a cable modem, a xDSL modem, or local area network. The data stream to one or more client devices can be transmitted over a packet network 11 such as the Internet by a device 10 (e.g., streaming server, etc.) configured to transmit data including data, media and video images. Although only one client device 12 is shown in this example, the same media stream may be transmitted to any number of client devices or the server may be transmitting media streams with differing content to different client devices.

The streaming broadcast server 10 or other communication component is coupled to the server 1, and is configured to receive content signals from a source or from the central data server 1 capable of linking viewers to digitized video files, audio files and other content across the packet network. The signal source may be supplied from one or more sources 2 and 3a-3d that include, for example, a terrestrial radio station or television station, or other service that provides audio and/or video programming content. For example, one or more digitized live broadcasts 3a-3d may be directed to central data server 1. The system 100 provided under this embodiment may be used to transmit live radio (audio) and/or video broadcasts. Streaming encoders (not shown) digitize, and if desirable, format and encode these signals as a data stream that can be directed to the central data server 1 for transmission across the packet based network 11. Moreover, a library of digitized video files 2 included within a storage system may be accessed by the central data server 1 for transmission or video streaming to remote client devices 12. It shall be understood that any type of data transport mechanism may be used to transmit the content signal in the system, including those that transmit the signal in a digital format. Other processes, not represented on the figure, may handle the transport of the media stream over the connection of the streaming server to the packet network.

An embodiment of the streaming systems streams live content (e.g., audio signals, video signals, etc.) in real time from at least one content source 3a-3d accessible to the central data server 1 and/or streaming broadcast server. In an embodiment, if the source of the content signal is a broadcast radio station or television network, the signal that is broadcast is also provided in real time for immediate streaming. Once the signal arrives at the server 1, an audio automation system can immediately connect it to a streaming encoder in order to prepare a data stream in suitable format for transmission across the packet network 11 to remote client devices 12.

Another aspect of the streaming systems 100 provides a streaming broadcast network with a selective content management system. The centralized data server 1 may be coupled to one or more databases including pre-selected information concerning subscribers and viewers. For example, a viewer access database 4 may include information concerning the various types of access levels each of the viewers are subscribers are permitted. This provides multi-tier pricing schemes for access to selected types of content received by users. At the same time, the central data server 1 may be coupled to a content database 5 that provides users with viewing information such as titles and title owners. The information relating to available titles available for streaming broadcast can be arranged according to a variety of selection menus as used in conventional broadcast programming.

An embodiment of the streaming systems 100 provides a streaming network broadcast system that incorporates advertising into the data stream to users. This provides an opportunity for generating revenue similar to present forms of Internet advertising. The advertising content may be updated and stored in an advertising database 6 coupled or connected to the central data server 1. At the same time, a database 7 including advertising fee account information can be coupled to the central data server 1 to track and calculate the revenue to be collected according the how many or how often selected advertising is injected into content data streams.

Another embodiment of the streaming systems includes an accounting system for tracking how often and to whom selected content is delivered. For example, the central data server 1 may be coupled to a accounting database 8 including information regarding which content titles have been selected for viewing and delivered to subscribers. As a result, the owners of the titles may be charged per stream delivered to a user for viewing. This alternative revenue stream could be applied in addition to or lieu of charging the user for delivery of the selected title or content stream.

Although not shown, streaming broadcast server 10 may transmit the media stream to other servers and/or one or more distribution networks that are coupled or connected to, or part of, packet network 1, in order to cache and/or geographically distribute the stream over high speed networks for purposes of enhancing delivery of the signal to each client computer 12. The stream may also be cached by these other services or networks. In addition, the streaming server 10 may also receive signals from more than one source and concurrently transmit more than one media stream. Furthermore, more than one streaming server may be used to transmit additional media streams.

A large community can be reached over a client-server network such as the World Wide Web (or “Web”) in order to exchange content and information in accordance with the streaming systems. The following description will be made in reference to a web server and a web browser as an example of a client-server application used to obtain information about streaming services and to setup streaming services. The Web has an advantage of being available for almost every type of computer. However, other client-server applications can be used to exchange set-up information for streaming services. The web browser and web server can be replaced by other types of applications capable of displaying text and/or graphic information, such as those that may be required for computers with limited display or computing capabilities. A client device can therefore include a web browser. The user may access a web page, such as an HTML encoded file, on which one or more links to choices of streaming content or v-channels. A user can request a stream by, for example, selecting a hyperlink on a web page. The web browser can send to a central data server a user identifier, which can be stored in a special user file on the client computer or entered manually by a user. The central data server can validate the user identifier. If there is no valid user identifier, then a registration process can be implemented through a registration page presented on a web browser.

The registration page can request information and a form into which information is entered. The requested information includes information with which to identify the user, such as an electronic mail (email) address, a telephone number, a credit card number, a digital signature and/or other like information. With such identifying information, the opportunity for duplicate registrations can be reduced. Furthermore, the identifying information, such as the email address can be, if desired, authenticated. The registration page or process may optionally request from the user certain demographic information, such as age, gender, income, place of residence, ethnicity, languages spoken, interests and/or the like. This optional information may also be used to target certain advertising to selected users in accordance with another embodiment of the streaming systems.

Once a user identifier is validated, the web browser may continue with the process of setting up the selected media stream for the user. The web browser may also send a request to central data server, using information associated with a selected link by the user, for information with which to set up the media stream. Included is information with which to identify the stream. When a request for a particular title or content is received by the server, the stream identifying information is passed on so that an appropriate file stored within a database within the network broadcast system can be transmitted. This data stream can be transmitted by the streaming broadcast server to client devices.

A session identifier may be used to uniquely identify a content streaming session to a client device. A broadcast streaming server can transmit a data stream to a client computer, which may preferably include a session or stream identifier that is stored by stream control logic on client device. This allows for controlling the streaming processes for playback on client device using its video system and/or a connected sound system. If a new stream identifier is selected and received by the client device, it can be played thereafter and another session identifier for a streaming session can be used in place of the stream ID to identify the stream that the user is then currently receiving.

The streaming systems 100 of an embodiment include one or more databases 9a available to the central data server 1 including information linking viewers to prerecorded broadcasts scheduled during virtual time slots. The timing for these prerecorded broadcasts may be established according to a predetermined clock in order to provide a relative time reference for these broadcasts.

In an embodiment of the streaming systems, a client device requests a media stream from a Universal Resource Locator (URL) received from a streaming broadcast server. For example, the URL can point to a particular streaming service on a streaming broadcast server, which is transmitting the stream from a central data server. The streaming broadcast server can begin transmitting the stream to client computer, which preferably includes a stream identifier that is stored by stream control logic in a browser or player application (applet) on the client computer. The browser or player application can have embedded in it or linked to it code that controls the streaming processes, and can decode the stream for playback on the client computer. When a stream terminates, the current stream identifier can be deleted. But if a new stream identifier is received, it can be stored and the playing process may continue on the client device. A session identifier for a streaming session can be used in place of the stream ID to identify the stream that the user is then currently receiving.

A client device can periodically send information to a central data server or streaming broadcast (web) server. This information may be automatically sent on a periodic basis, and may preferably include a user identifier, a session identifier and a stream identifier. This exchange of information can be also used by ad display logic resident on or in communication with the central data server as part of a request from the client device for selected or updated URL. Additional data including relative or absolute time, timecode, frame number and/or coordinates within a frame or frames of a media stream may be added to one or more streams to provide a rich media message, such as an advertisement. This rich media advertisement may include text, static graphic components, and/or active components, and may come from any third party advertisers. For example, such components may be for example a video component in MPEG, QT, MOV or other format, a presentation in Flash, an animated GIF and/or the like.

Such advertisements may be displayed at the client device in a rich media advertising window, which is in an embodiment a web browser window or alternatively displayed in a window with controls (such as volume controls) for a streaming media player application on the monitor of the client computer. Thus, when a user is receiving a media stream, the user is also viewing an advertisement. The ad display logic can be implemented either as a periodic web page refresh or through client/server software. Once the URL for the rich media advertisement is received, the rich media advertisement may be included in the media stream or can be simultaneously displayed alongside the selected media stream(s). At least a portion of the received rich media advertisement can be displayed at some predetermined time slot (e.g., beginning, end) during a video, audio and/or other data stream and may be linked to relative or absolute time, timecode, frame, frames and/or coordinate position within frame/frames of media stream. The player application or browser can wait for a prescribed time before repeating this targeted advertising process. Advertising can also be scheduled remotely using a separate web server connected to the central data server having advertising scheduling logic.

Referring to the streaming system 100, a centralized content management and advertising system is provided in which one or more client computers 12 may view streamed content that can be targeted for each subscriber. The system allows remote viewing of video or audio streamed content in real time through a browser over a public packet network, and at the same time it can monitor how many people are actually viewing or listening to selected content, as well as when they listened and how long they accessed such content. This feature may be made available to the content providers and to advertisers, as it also indicates who has listened to and/or viewed advertisements

An alternative embodiment for a client-server system provided herein can be adapted for simultaneously streaming audio and video streams, tracking users, selecting and delivering advertisements in real time and pushing rich media advertising. In an embodiment of the streaming systems, a traffic management system can write to an ad scheduling database information identifying which streaming advertisement was played and when it was played. Other information, including criteria used to select the advertisement and information for determining which rate to be charged an advertiser, can also be written to the ad scheduling database for use by a billing system to create statements or bills for the advertisers. This information may include the time of day, the number of users who received the streaming advertisement, the demographic information of the users, the selected station or v-channel identifiers, the spot number and/or the like.

In an embodiment of the streaming systems, the demographic composition of users to whom a particular streaming media is being transmitted can be used as criteria to select a particular streaming advertisement. The traffic management logic preferably determines the demographic composition of the users listening to a particular stream. Thus, selection of an advertisement for streaming may be, if desired, based on whether the demographic composition of the users matches or fits the demographic profile associated with the particular advertisement. The demographic composition of the users can be determined by accessing a session records database and identifying the user identifiers associated with a particular streaming session.

Information about the preferred target audience of a particular advertisement may be associated with the advertisement and stored in the ad scheduling database along with the particular advertisement. Thus, information from a viewer/access/advertiser database may be used to select a particular advertisement to be played. Thus, whether a particular advertisement is selected for playing will depend, at least in part, on the demographic profile, such as for example the age, gender, income, place of residence, ethnicity, interests and/or the like of the users and could partially depend on a bid relative to other advertisers bids for the media stream. For example, an advertiser may have two “spots”, one targeted for one demographic and the other targeted to a different demographic. The most appropriate advertisement can be selected based on which demographic is most prevalent among the users and which advertisers bid generates the most profit for the media stream. Furthermore, if desired, each of these demographic criteria may be given a particular weight in the selection process such that a particular demographic criteria is given more importance in the selection process. For example, advertisers for local goods and/or services may be more interested in the geographical location of a user, then their income and thus, may assign a greater weight to the place of residence.

It shall be understood that these and other concepts relating to various aspects of the streaming systems may be applied to streaming media and advertising systems and related methods such as those described in the following which are hereby incorporated by reference in their entirety: U.S. Patent Publication Nos. 2004/0133467 and 2002/0067730.

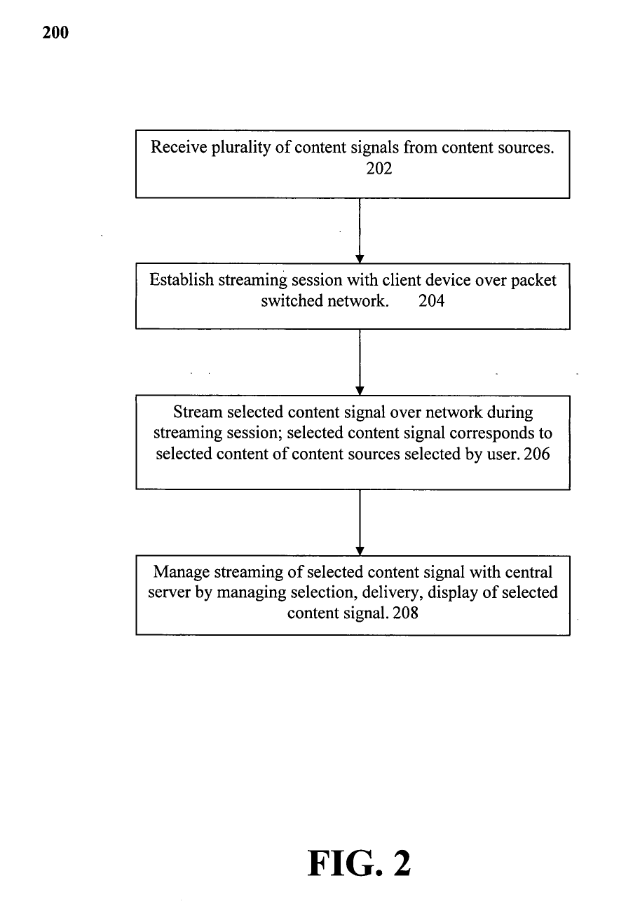

FIG. 2 is a flow diagram of streaming data 200 across a packet based network, under an embodiment. Operations for streaming data 200 begin with receiving 202 one or more content signals from content sources. A streaming session is established 204 with at least one client device. The streaming session is established 204 over a packet switched network in an embodiment. Streaming 206 of a selected content signal occurs over the network during the streaming session. The selected content signal of an embodiment corresponds to selected content of the content sources selected by a user. Management 208 of the streaming of the selected content signal is conducted, for example, at a central server. The management 208 includes managing selection, delivery, and display of the selected content signal.

An operational or functional example of the streaming system of an embodiment follows. This example is presented as but one example of the streaming system operations and is not intended to limit the embodiments herein. The client device is activated, and the client device couples or connects to the server and opens a guest session. The server assembles an initial selection screen including but not limited to representations of links to content, direct links to content, authentication requests, direct links or representations of links to advertisers, and links or representations of links for new selection screens to name a few. The server transmits the assembled initial selection screen to the client device where the selection screen is displayed.

The user at the client device selects content for viewing via the initial selection screen received and displayed. Information about the selected content is transferred to the server, and the server identifies the request based upon the received information of the selected content. When the requested selection is a link or representation of a link for a new selection screen, the server assembles or generates a new selection screen and transmits new selection screen to the client device in response to the request.

When the requested selection is a direct link to content or representation of a link to content, the server validates the client device authentication against content permissions. If the authentication against content permissions is valid, content is transmitted to the client device, tracking information regarding this transaction is stored in a data storage format and, if applicable, a credit or debit may be applied to either the authenticated user account, an account for the content owner, and/or an account for an advertiser. If the authentication against content permissions is invalid, the server transmits an authentication screen to the client device.

When the requested selection is an authentication request the server validates authentication against a valid username and valid password contained in a data storage format. If a valid username and valid password are authenticated, the server opens an authenticated session and assembles an initial selection screen including but not limited to representations of links to content, direct links to content, authentication requests, direct links or representations of links to advertisers, and links or representations of links for new selection screens to name a few. The server transmits an authentication screen to the client device if the usemame and password are not authenticated.

When the requested selection is a direct link or representation of a link to an advertiser the server transmits an advertisement screen to the client device for display. The advertisement screen is specified by an advertiser but is not so limited. Tracking information regarding this transaction is stored in a data storage format. Further, and if applicable, a credit or debit may be applied to the authenticated user account, an account for a content owner, and/or an account for an advertiser.

Systems and methods are described for integrating and distributing live, pre-recorded and/or on-demand digital content via a packet network. The packet network includes but is not limited to the Internet, for example. The systems and methods include systems and methods for streaming media over packet networks that include receiving a plurality of content signals from a live, pre-recorded and on-demand digital content source. The method for streaming media includes establishing a streaming session for a selected content signal that is transmitted to a user computer over a packet switched data network, and streaming the selected content signal over the data network during said streaming session. The streaming of the selected content signal is managed and tracked using a central data server that is in communication with one or more other components. The components with which the central data server can communicate include one or more of a viewer access database, a content database that includes names and titles to available content from available sources, a viewer advertising database, and an accounting database that includes fees to be applied to title owners of content signals when selected for transmission over the packet switched data network.

The systems and methods for streaming media content via a broadcast system that includes one or more of system components. The system components include, for example, a centralized server or server system configured to enable all live, pre-recorded and/or on-demand content to be qualified, monetized, organized, controlled, monitored, tracked and protected. The system components of an embodiment also include a centralized server or server system configured to assemble and transmit a user interface to be displayed on one or more remote user viewing devices such as a computers configured with a web browser, dedicated devices configured to interface with the centralized server or server system, or custom player software configured to run on a processor-based device. The system components of an embodiment include a user interface configured to allow the viewer to select from a subset of combined available live, pre-recorded and/or on-demand content provided by the centralized server or server system.

The streaming systems of an embodiment include a method comprising receiving a plurality of content signals from content sources. The method of an embodiment includes establishing a streaming session with a client device over a packet switched network. The method of an embodiment includes streaming a selected content signal over the network during the streaming session. The selected content signal of an embodiment corresponds to selected content of the content sources selected by a user. The method of an embodiment includes managing the streaming of the selected content signal with a central server. The managing of an embodiment includes managing selection, delivery, and display of the selected content signal.

The content sources of an embodiment include one or more of live media, pre-recorded media, and on-demand media content.

The packet switched network of an embodiment includes the Internet.

The managing of an embodiment includes communicating with a content database to receive names and titles of available content corresponding to the plurality of content signals.

The managing of an embodiment includes communicating with a viewer access database to receive one or more of access level, subscription type, permissions, and account data of the user. The account data of an embodiment includes one or more of a name, physical address, electronic mail address, telephone number, billing data, credit card number, and digital signature of the user.

The managing of an embodiment includes communicating with an advertising database to receive advertising content.

The method of an embodiment includes automatically selecting advertising content from the advertising database. The method of an embodiment includes integrating the selected advertising content into the streaming session.

The selecting of the advertising content of an embodiment comprises selecting the advertising content according to demographic data of the user.

The method of an embodiment includes tracking and calculating advertising revenue to be collected from an advertiser corresponding to the selected advertising content.

The managing of an embodiment includes communicating with an accounting database to receive fees to be applied to title owners of content signals when selected for transmission over the packet switched data network.

The managing of an embodiment includes one or more of organizing, controlling, monitoring, tracking, qualifying, monetizing, and protecting the content.

The method of an embodiment includes receiving selection data from the client device, the selection data corresponding to the selected content signal.

The method of an embodiment includes transferring menu data to the client device. The selected content of an embodiment is selected using the menu data.

The method of an embodiment includes transferring the menu data to the client device via the streaming session.

The menu data of an embodiment includes content data comprising a plurality of media available from the content sources. The plurality of media of an embodiment comprises virtual channels, wherein the content data includes one or more of title, title owner, description, participant names, and date.

The method of an embodiment includes transferring the menu data to the client device via a universal resource locator (URL). The URL of an embodiment points to a source of the streaming of the selected content signal.

The method of an embodiment includes presenting menu data to the user via a web page. The selected content of an embodiment is selected using the menu data. The menu data of an embodiment includes content data comprising a plurality of media available from the content sources. The plurality of media of an embodiment comprises virtual channels. The content data of an embodiment includes one or more of title, title owner, description, participant names, and date.

The method of an embodiment includes generating and transmitting a user interface for display at the client device.

The method of an embodiment includes presenting the selected content at the client device via the stream.

The streaming systems of an embodiment include a system comprising a server coupled to a plurality of content sources and configured to receive a plurality of content signals from the plurality of content sources. The system of an embodiment includes a communication device coupled to the server and to a packet switched network. The server of an embodiment is configured to establish a streaming session with a client device of a user over the packet switched network. The server of an embodiment is configured to stream a selected content signal over the network during the streaming session. The selected content signal of an embodiment corresponds to selected content of the content sources selected by a user. The server of an embodiment is configured to manage the streaming of the selected content signal with a central server. The managing of an embodiment includes managing selection, delivery, and display of the selected content signal.

The plurality of content sources of an embodiment includes one or more of a pre-recorded media source and an on-demand media source.

The plurality of content sources of an embodiment includes at least one live media source.

The system of an embodiment includes a content database coupled to the server. The content database of an embodiment includes names and titles of available content corresponding to the plurality of content signals.

The system of an embodiment includes a viewer access database coupled to the server. The viewer access database of an embodiment includes access level, subscription type, permissions, and account data of the user, the account data including one or more of a name, physical address, electronic mail address, telephone number, billing data, credit card number, and digital signature of the user.

The system of an embodiment includes an advertising database coupled to the server. The advertising database of an embodiment includes advertising content. The server of an embodiment is configured to automatically select advertising content from the advertising database and integrate the selected advertising content into the streaming session.

The system of an embodiment includes an accounting database coupled to the server. The accounting database of an embodiment includes fee data to be applied to title owners of content signals when selected for transmission over the packet switched data network. The server of an embodiment is configured to use the fee data to calculate and track revenue due the title owners.

The server of an embodiment is configured to receive selection data from the client device and in response to generate the stream including the selected content signal.

The server of an embodiment is configured to generate menu data that includes content data comprising a plurality of media available from the content sources. The plurality of media of an embodiment comprises virtual channels. The content data of an embodiment includes one or more of title, title owner, description, participant names, and date.

The stream of an embodiment includes the menu data.

The server of an embodiment is configured to transfer the menu data to the client device via a universal resource locator (URL). The URL of an embodiment points to at least one content source of the plurality of content sources that includes the selected content signal.

The server of an embodiment is configured to generate and present a web page that includes the menu data. The selected content of an embodiment is selected using the menu data.

The server of an embodiment is configured to generate and transmit a user interface over the packet switched network. The user interface of an embodiment is presented at the client device.

The streaming systems of an embodiment include a computer readable media including executable instructions which, when executed in a processing system, provide content delivery via streaming by receiving a plurality of content signals from content sources. The content sources of an embodiment include one or more of live media, pre-recorded media, and on-demand media content. The instructions of an embodiment, when executed, provide content delivery via streaming by establishing a streaming session with a client device over a packet switched network. The instructions of an embodiment, when executed, provide content delivery via streaming by streaming a selected content signal over the network during the streaming session. The selected content signal of an embodiment corresponds to selected content of the content sources selected by a user. The instructions of an embodiment, when executed, provide content delivery via streaming by managing the streaming of the selected content signal with a central server. The managing of an embodiment includes managing selection, delivery, and display of the selected content signal.

The managing of an embodiment comprises communicating with a content database to receive names and titles of available content corresponding to the plurality of content signals. The managing of an embodiment comprises communicating with a viewer access database to receive access level, subscription type, permissions, and account data of the user. The account data of an embodiment includes one or more of a name, physical address, electronic mail address, telephone number, billing data, credit card number, and digital signature of the user. The managing of an embodiment comprises communicating with an accounting database to receive fees to be applied to title owners of content signals when selected for transmission over the packet switched data network.

The managing of an embodiment includes automatically selecting advertising content from the advertising database. The managing of an embodiment includes integrating the selected advertising content into the streaming session. The managing of an embodiment includes tracking and calculating advertising revenue to be collected from an advertiser corresponding to the selected advertising content.

The instructions of an embodiment, when executed, provide content delivery via streaming by generating menu data. The selected content of an embodiment is selected using the menu data. The menu data of an embodiment includes content data comprising a plurality of media available from the content sources. The plurality of media of an embodiment comprises virtual channels. The content data of an embodiment includes one or more of title, title owner, description, participant names, and date.

While the streaming systems have been described with reference to the aforementioned specification, the descriptions and illustrations of the embodiments herein are not meant to be construed in a limiting sense. It shall be understood that all aspects of the streaming systems are not limited to the specific depictions, configurations or relative proportions set forth herein which depend upon a variety of conditions and variables. Various modifications in form and detail of the embodiments of the streaming systems will be apparent to a person skilled in the art upon reference to the present disclosure. It is therefore contemplated that the appended claims shall also cover any such modifications, variations and equivalents.

What is claimed is:

1. A method comprising:
receiving a plurality of content signals from content sources;
establishing a streaming session with a client device over a packet switched network;
streaming a selected content signal over the network during the streaming session, the selected content signal corresponding to selected content of the content sources selected by a user; and
managing the streaming of the selected content signal with a central server, wherein the managing includes managing selection, delivery, and display of the selected content signal.

2. The method of claim 1, wherein the content sources include one or more of live media, pre-recorded media, and on-demand media content.

3. The method of claim 1, wherein the packet switched network includes the Internet.

4. The method of claim 1, wherein the managing includes communicating with a content database to receive names and titles of available content corresponding to the plurality of content signals.

5. The method of claim 1, wherein the managing includes communicating with a viewer access database to receive one or more of access level, subscription type, permissions, and account data of the user, the account data including one or more of a name, physical address, electronic mail address, telephone number, billing data, credit card number, and digital signature of the user.

6. The method of claim 1, wherein the managing includes communicating with an advertising database to receive advertising content.

7. The method of claim 6, comprising:
automatically selecting advertising content from the advertising database; and
integrating the selected advertising content into the streaming session.

8. The method of claim 7, wherein the selecting of the advertising content comprises selecting the advertising content according to demographic data of the user.

9. The method of claim 7, comprising tracking and calculating advertising revenue to be collected from an advertiser corresponding to the selected advertising content.

10. The method of claim 1, wherein the managing includes communicating with an accounting database to receive fees to be applied to title owners of content signals when selected for transmission over the packet switched data network.

11. The method of claim 1, wherein the managing includes one or more of organizing, controlling, monitoring, tracking, qualifying, monetizing, and protecting the content.

12. The method of claim 1, comprising receiving selection data from the client device, the selection data corresponding to the selected content signal.

13. The method of claim 1, comprising transferring menu data to the client device, wherein the selected content is selected using the menu data.

14. The method of claim 13, comprising transferring the menu data to the client device via the streaming session.

15. The method of claim 13, wherein the menu data includes content data comprising a plurality of media available from the content sources, wherein the plurality of media comprise virtual channels, wherein the content data includes one or more of title, title owner, description, participant names, and date.

16. The method of claim 13, comprising transferring the menu data to the client device via a universal resource locator (URL), wherein the URL points to a source of the streaming of the selected content signal.

17. The method of claim 1, comprising presenting menu data to the user via a web page, wherein the selected content is selected using the menu data, wherein the menu data includes content data comprising a plurality of media available from the content sources, wherein the plurality of media comprise virtual channels, wherein the content data includes one or more of title, title owner, description, participant names, and date.

18. The method of claim 1, comprising generating and transmitting a user interface for display at the client device.

19. The method of claim 1, comprising presenting the selected content at the client device via the stream.

20. A system comprising:
a server coupled to a plurality of content sources and configured to receive a plurality of content signals from the plurality of content sources; and
a communication device coupled to the server and to a packet switched network, wherein the server is configured to establish a streaming session with a client device of a user over the packet switched network, wherein the server is configured to stream a selected content signal over the network during the streaming session, the selected content signal corresponding to selected content of the content sources selected by a user, wherein the server is configured to manage the streaming of the selected content signal with a central server, wherein the managing includes managing selection, delivery, and display of the selected content signal.

21. The system of claim 20, wherein the plurality of content sources include one or more of a pre-recorded media source and an on-demand media source.

22. The system of claim 20, wherein the plurality of content sources include at least one live media source.

23. The system of claim 20, comprising a content database coupled to the server, wherein the content database includes names and titles of available content corresponding to the plurality of content signals.

24. The system of claim 20, comprising a viewer access database coupled to the server, wherein the viewer access database includes access level, subscription type, permissions, and account data of the user, the account data including one or more of a name, physical address, electronic mail address, telephone number, billing data, credit card number, and digital signature of the user.

25. The system of claim 20, comprising an advertising database coupled to the server, wherein the advertising database includes advertising content, wherein the server is configured to automatically select advertising content from the advertising database and integrate the selected advertising content into the streaming session.

26. The system of claim 20, comprising an accounting database coupled to the server, wherein the accounting database includes fee data to be applied to title owners of content signals when selected for transmission over the packet switched data network, wherein the server is configured to use the fee data to calculate and track revenue due the title owners.

27. The system of claim 20, wherein the server is configured to receive selection data from the client device and in response to generate the stream including the selected content signal.

28. The system of claim 20, wherein the server is configured to generate menu data that includes content data comprising a plurality of media available from the content sources, wherein the plurality of media comprise virtual channels, wherein the content data includes one or more of title, title owner, description, participant names, and date.

29. The system of claim 28, wherein the stream includes the menu data.

30. The system of claim 28, wherein the server is configured to transfer the menu data to the client device via a universal resource locator (URL), wherein the URL points to at least one content source of the plurality of content sources that includes the selected content signal.

31. The system of claim 28, wherein the server is configured to generate and present a web page that includes the menu data, wherein the selected content is selected using the menu data.

32. The system of claim 20, wherein the server is configured to generate and transmit a user interface over the packet switched network, wherein the user interface is presented at the client device.

33. A computer readable media including executable instructions which, when executed in a processing system, provide content delivery via streaming by:
receiving a plurality of content signals from content sources, wherein the content sources include one or more of live media, pre-recorded media, and on-demand media content;
establishing a streaming session with a client device over a packet switched network;
streaming a selected content signal over the network during the streaming session, the selected content signal corresponding to selected content of the content sources selected by a user; and
managing the streaming of the selected content signal with a central server, wherein the managing includes managing selection, delivery, and display of the selected content signal.

34. The media of claim 33, wherein the managing comprises:
communicating with a content database to receive names and titles of available content corresponding to the plurality of content signals;
communicating with a viewer access database to receive access level, subscription type, permissions, and account data of the user, the account data including one or more of a name, physical address, electronic mail address, telephone number, billing data, credit card number, and digital signature of the user; and
communicating with an accounting database to receive fees to be applied to title owners of content signals when selected for transmission over the packet switched data network.

35. The media of claim 33, wherein the managing comprises:
automatically selecting advertising content from the advertising database;
integrating the selected advertising content into the streaming session; and
tracking and calculating advertising revenue to be collected from an advertiser corresponding to the selected advertising content.

36. The media of claim 33, comprising generating menu data, wherein the selected content is selected using the menu data, wherein the menu data includes content data comprising a plurality of media available from the content sources, wherein the plurality of media comprise virtual channels, wherein the content data includes one or more of title, title owner, description, participant names, and date.
